(19) United States
(12) Patent Application Publication
(10) Pub. No.: US 2022/0126323 A1
(43) Pub. Date: Apr. 28, 2022

(54) Rolling Sifter

(71) Applicant: Cheryl Ann Smyth, Leesville, LA (US)

(72) Inventor: Cheryl Ann Smyth, Leesville, LA (US)

(21) Appl. No.: 17/079,398

(22) Filed: Oct. 23, 2020

(51) Int. Cl. B07B 1/22; B07B 1/00

(52) U.S. Cl. CPC B07B 1/22; B07B 1/005

(57) ABSTRACT

An apparatus for sifting soil and other material comprising a trammel and a frame with legs allowing it to be fitted to a wheelbarrow or other rolling container device.

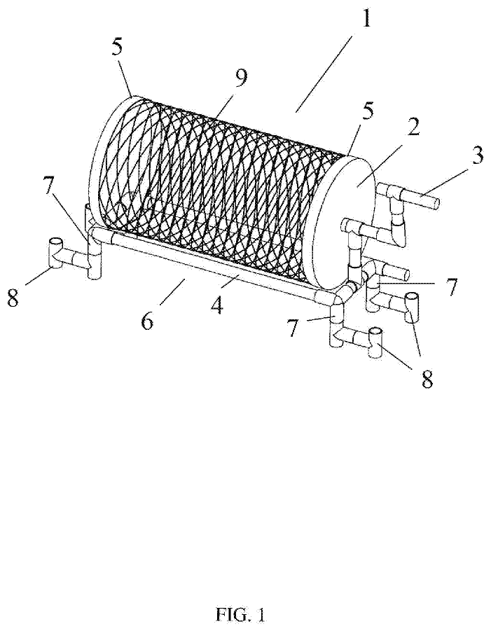

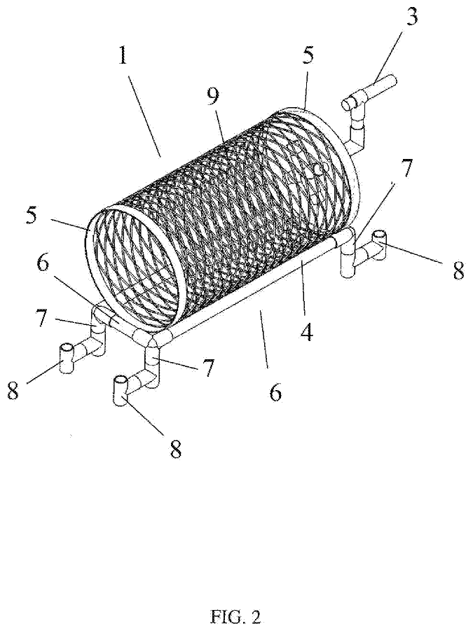

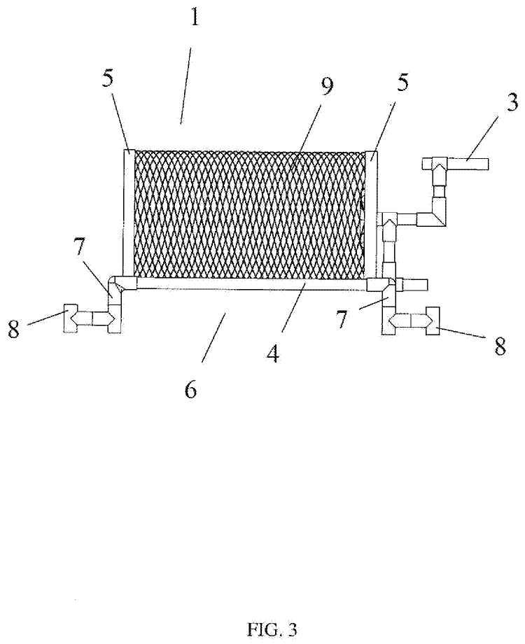

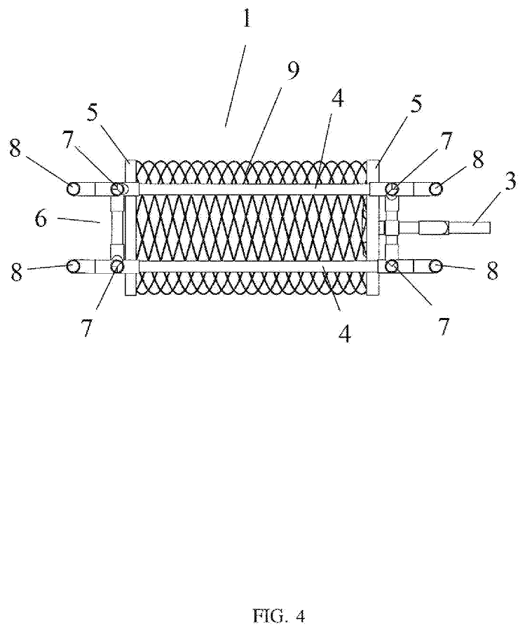

### BACKGROUND OF THE INVENTION

The present invention relates generally to sifters. Although this is only one of many applications for sifting and sorting, the embodiment of the invention described herein relates more specifically to the sifting of soil, compost, and other materials in order to perfect them for gardening. In many cases soils may be more effectively reused and even newly purchased soils may be improved by removing larger materials such as pebbles, leaves, clogs of clay, and living organisms such as bugs or worms. This process is most often accomplished by sifting.

### DESCRIPTION OF THE PRIOR ART

Although sifting of soil has been done throughout the ages, many methods of sifting lack the efficiency and ease of operation required for maximum results. Many sifting methods, such as simply putting material in a screened container and shaking it are labor intensive, slow in operation, and do not deal with waste materials. Flat screen sifting requires a large area for product collection and likewise does not discard waste. There has been a need for sifting equipment that is portable, easy to operate, and can easily and efficiently gather finished product and discard waste materials. Solutions to these problems have been offered in the provisional application of Cheryl Ann Smyth entitled Rolling Sifter filed on Aug. 15, 2019, application No. 62/887,393. These solutions are further addressed by this application.

### BRIEF DESCRIPTION OF THE DRAWINGS

FIG. (1) is a front-top-right perspective view of the rolling sifter.

FIG. (2) is a front-top-left perspective view of the rolling sifter.

FIG. (3) is a front elevation view of the rolling sifter.

FIG. (4) is a bottom elevation view of the rolling sifter.

### DETAILED DESCRIPTION

Referring to the drawings and more specifically to FIG. (1), it can be seen that the Rolling Sifter comprise a trammel, further comprising a cylindrical mesh/sieve sifting member 1. Cylindrical mesh/sieve sifting member 1 is open on one end. The remaining end is closed on the other end by disk member 2. A handle 3 is co-axially affixed to the center of disk member 2 so that the cylindrical mesh/sieve sifter member 1 may be rotated by rotating handle 3. Cylindrical mesh/sieve sifting member 1 is supported and rests upon rectangular support frame 4. Support frame 4 is generally rectangular in shape and may be constructed of any suitable material. It is just slightly longer than cylindrical mesh/sieve sifting member 1 and is sufficient in width to disallow cylindrical mesh/sieve sifting member 1 from falling through or over the side of support frame 4. Handle 3 slides inward and outward with regard to support frame 4 for additional support. Cylindrical mesh/sieve sifting member 1 is equipped with a rigid support band 5 at each end. Support bands 5 rest upon side bars 6 of the support frame 4. As handle 3 is rotated, cylindrical mesh/sieve sifting member 1 is rotated on support frame 4 with support bands 5 being supported by side bars 6 of support frame 4 at either end. A support leg 7 is affixed to each of the four corners of rectangular support frame 4. These support legs 4 rest upon the bottom surface of a wheel barrow, tub, roll cart, or whatever suitable apparatus that the rolling sifter is being moved along by. Support leg adjusters 8 are pivotally attached to support legs 7 and rotate inward and outward so as to accommodate the top rim of the wheelbarrow or cart that is being used for transport.

Cylindrical mesh/sieve sifting member 1 is filled with soil, compost, or whatever the user wishes to sift through its open end. Cylindrical mesh/sieve sifting member 1 is removably attached to handle 3 and may be removed and stood vertically for ease of fill. As cylindrical mesh/sieve sifter member 1 is rotated, prepared soil drops through the screen mesh 9 of cylindrical mesh/sieve sifting member 1 and is collected by the wheelbarrow, tub, or roll cart on which it is being transported while leaves, pebbles and other debris exit cylindrical mesh/sieve sifting member 1 through its open end. When all desired soil has been sifted, the Rolling Sifter is lifted from the wheelbarrow, tub, or roll cart and set aside so that the prepared soil may be transported to its place of use.

I claim:

1. An apparatus for sifting soil or other matter, comprising a cylindrical mesh/sieve sifting member, said cylindrical mesh/sieve sifting member further comprising mesh cylinder walls, said mesh cylinder walls further comprising a plurality of sifting holes through which said soil or other matter may pass, said cylindrical mesh/sieve sifting member having a length and a diameter, said sifting member having a forward end and a rearward end, said forward end being open, said rearward end being closed by a disk shaped member, said sifting member further comprising a rotating handle, said rotating handle further comprising an axle and a hand grip, said axle being coaxially affixed to said disk so as to rotate said cylindrical mesh/sieve sifting member.

2. An apparatus as described in claim 1 wherein said apparatus further comprises a rectangular support frame, said support frame comprising a frame length and a frame width, said frame length being slightly longer than said length of said cylindrical mesh/sieve sifting member, said support frame width being slightly smaller than said diameter of said cylindrical mesh/sieve sifting member so that said cylindrical mesh/sieve sifting member will sit upon and partially traverse said rectangular support frame, said cylindrical mesh/sieve sifting member further comprising two rigid support bands, said support bands having a diameter, said diameter being equal to said diameter of said cylindrical mesh/sieve sifting member, one of said support bands being co-axially affixed to said forward end of said cylindrical mesh/sieve sifting member, and the remaining support band being co-axially affixed to said rearward end of said cylindrical mesh/sieve sifting member, said cylindrical mesh/sieve sifting member riding upon said support bands against said rectangular support frame.

3. An apparatus as described in claim 2, wherein said rotating handle further comprises a sleeve bearing, said rotating handle being affixed to said rectangular support frame through said sleeve bearing.

4. An apparatus as described in claim 3, wherein said rectangular support frame further comprises four corners, said rectangular support frame further comprising four support legs, said support legs having a top and a bottom, said tops of said support legs being affixed to said rectangular support frame at said corners.

5. An apparatus as described in claim 4, wherein each of said support legs further comprises a support leg adjuster, each said support leg adjuster being pivotally attached to said bottom of said support leg.

6. An apparatus as described in claim 5, wherein said sifting holes are rectangular in shape.

7. An apparatus as described in claim 5, wherein said sifting holes are oval in shape.

8. An apparatus as described in claim 5, wherein said sifting holes are diamond shaped.
